(19) United States
(12) Patent Application Publication
(10) Pub. No.: US 2016/0360925 A1
(43) Pub. Date: Dec. 15, 2016

(54) Charcoal Grill Comprising a Height-Adjustable Charcoal Rack

(71) Applicant: TEPRO Garten GmbH, Roedemark (DE)

(72) Inventor: Zhang Xin Chun, Bailontang Town Shaanxi (CN)

(21) Appl. No.: 15/172,693

(22) Filed: Jun. 3, 2016

(30) Foreign Application Priority Data
Jun. 9, 2015 (DE) 102015109093.7

(51) Int. Cl. A47J 37/07

(52) U.S. Cl. CPC A47J 37/0704; A47J 2037/0795

(57) ABSTRACT

A charcoal grill (1) includes a charcoal rack (3) arranged in a grill housing (2) and a lifting device (4) for the charcoal rack (3). First and second actuating bars (6, 9) are pivotably mounted to sides of the charcoal rack (3). First and second guide bars (7, 10) are pivotably mounted to the charcoal rack and mounted on brackets (5, 8) in the grill housing (2). The guide bars (7, 10) and the brackets (5, 8) are configured such that for attaching the charcoal rack (3), an actuating shaft (11) is initially introduced into the first bracket (5) and subsequently by axial displacement is inserted with one end into the second bracket (8). Simultaneously, the first guide bar (7) is inserted into the first bracket (5) and the second guide bar (10) is inserted into the second bracket (8).

### CROSS-REFERENCE TO RELATED APPLICATIONS

The instant application claims the priority date of Jun. 9, 2015, the filing date of the German patent application DE 10 2015 109 093.7.

### BACKGROUND OF THE INVENTION

The present invention relates to a charcoal grill having a charcoal rack arranged in a grill housing and a lifting device for the charcoal rack which, on a first side of the charcoal rack, has a first actuating bar pivotably mounted on the charcoal rack and pivotably mounted relative to a first bracket configured in the grill housing. A first guide bar is oriented parallel to the first actuating bar and pivotably mounted on the charcoal rack and pivotably mounted on the first bracket. A second actuating bar is pivotably mounted on the charcoal rack on a second side of the charcoal rack and pivotably mounted relative to a second bracket configured in the grill housing. A second guide bar is oriented parallel to the second actuating bar and pivotably mounted on the charcoal rack and pivotably mounted on the second bracket. The first actuating bar and the second actuating bar are connected together fixedly in terms of rotation at their ends facing the brackets by an actuating shaft, so that the charcoal rack is lifted or lowered by rotating the actuating shaft.

A charcoal grill having the aforementioned features is disclosed in CN 102067893 A, in which an actuating element is fastened fixedly in terms of rotation to the actuating shaft of the lifting device, so that the actuating shaft is able to be rotated by means of the actuating element about the rotational axis thereof. The actuating element is actuated by a crank mounted on the grill housing, wherein the end of the crank predetermines the deflection of the actuating element and thereby the rotational position of the actuating shaft rotatably mounted in the brackets. As the actuating bars are rigidly connected to the actuating shaft, the rotational position of the actuating shaft corresponds to the pivoted position of the actuating bars, whereby the height of the charcoal rack in the grill housing is predetermined. If the crank, for example, is fully rotated into the thread fastened to the grill housing, the charcoal rack adopts the highest position. If the crank is rotated out of the thread, the charcoal rack is lowered. As the bars and the actuating shaft of the lifting device are fixedly connected to the brackets fastened to the grill housing, the charcoal rack and the lifting device are only able to be removed from the charcoal grill for cleaning by a large amount of effort.

### SUMMARY OF THE INVENTION

It is the object of the present invention, therefore, to solve the problem set forth with reference to the prior art and, in particular, to provide a charcoal grill in which a charcoal rack which is height-adjustable by means of a lifting device is able to be removed from and reintroduced into the charcoal grill in a simple manner.

The object is achieved, in particular, by a charcoal grill having the features set forth in the introduction, wherein the guide bars and the brackets are configured such that for attaching the charcoal rack the actuating shaft is initially introduced into the first bracket, in particular suspended, and subsequently by axial displacement in the direction of the longitudinal extent of the actuating shaft, the actuating shaft is inserted with one end into the second bracket, wherein at the same time the first guide bar is inserted into the first bracket and the second guide bar is inserted into the second bracket.

It is thus provided that the lifting device comprising the bars and the actuating shaft is releasably connected in a simple manner to the brackets attached to the grill housing. To this end, the first bracket, in particular, comprises a receiver which is open toward the upper edge thereof, the actuating shaft being initially introduced therein when inserting the charcoal rack and the lifting device into the grill housing. Subsequently, the lifting device with the bars and the actuating shaft and the charcoal rack are moved laterally in a horizontal direction, wherein one end of the actuating shaft and, at the same time, the second guide bar are inserted into the second bracket, in particular into holes in the second bracket. The first guide bar, with the horizontal movement, is additionally inserted into a corresponding hole in the first bracket. For removing the lifting device and the charcoal rack, these components initially have to be displaced to the side, whereby the end of the actuating shaft and the guide bars move out of the holes in the brackets. Subsequently, the lifting device has to be simply lifted again with the charcoal rack, wherein the actuating shaft moves out of the receiver of the first bracket.

In the mounted state, the actuating bars are pivotably mounted on the brackets, in particular by means of the actuating shaft, while the guide bars are, in particular, pivotably mounted directly in the brackets. In particular, an actuating element protruding radially from the actuating shaft is configured on the actuating shaft, said actuating element being able to be deflected by a spindle guided in a thread attached to the grill housing about the axis of the actuating shaft. The deflection of the actuating element thus predetermines the rotational position of the actuating shaft. The rotation of the actuating shaft about the shaft axis thereof in turn ensures that the actuating bars connected rigidly to the actuating shaft are pivoted, whereby the height of the charcoal rack attached to the pivotable ends of the actuating bars in the grill housing is altered. The guide bars oriented parallel to the respective actuating bar ensure that the charcoal rack is always oriented horizontally and is not able to swing.

It may be provided that the first guide bar and the second guide bar are inserted into the brackets in each case with an angled end. The ends of the guide bars are, in particular, oriented at right angles relative to the path thereof adjoining the ends, and are inserted into the brackets with the lateral movement during mounting.

The actuating bars and the guide bars in each case may be pivotably mounted on the charcoal rack directly or indirectly via at least one additional element. For example, the actuating bar and the guide bar on one side of the charcoal rack may be pivotably mounted in a plate attached to the charcoal rack.

In one embodiment of the charcoal grill, it may be provided that the first guide bar and the second guide bar are formed as portions of a guide element configured in one piece and a rotatably mounted connecting portion of the guide element extends below the charcoal rack. The guide element thus consists of the portions forming the first guide bar and the second guide bar and a connecting portion connecting the guide bars, which is arranged below the charcoal rack. Thus the two guide bars are rigidly connected together and are pivotably mounted together on the charcoal rack, so that during mounting the guide bars always have the same orientation to one another and thus for insertion into the brackets are able to be oriented together. For example, during mounting only the first guide bar has to be oriented relative to the recess in the first bracket, so that at the same time the second guide bar is oriented relative to the recess in the second bracket.

It may be provided, in particular, that the guide bars are formed from a rod-shaped material which is circular in cross section so that, in particular, the angled ends may be pivotably mounted in a simple manner on the brackets.

In one embodiment, it may be provided that the actuating shaft protrudes outwardly over the second actuating bar. The actuating shaft, in particular in the region of the first actuating bar, is suspended in the first bracket and then inserted into the recess in the second bracket with the region protruding over the second actuating bar.

So that the first actuating bar and the second actuating bar in each case are already aligned during mounting parallel to the guide bars, it may be provided that at least the first actuating bar and the first guide bar or the second actuating bar and the second guide bar are connected together via one respective connecting element pivotably mounted on the two bars.

### BRIEF DESCRIPTION OF THE DRAWINGS

The invention and the technical background are described hereinafter with reference to the drawings, wherein reference should be made to the fact that the drawings show a preferred embodiment of the invention. In the drawings, schematically:

FIG. 1 shows a charcoal grill;

FIG. 2 shows a charcoal grill with the cover open;

FIG. 3 shows a charcoal rack with a lifting device;

FIG. 4 shows the charcoal rack mounted with the lifting device on a grill housing; and

FIG. 5 shows the mounting steps of the charcoal rack.

### DETAILED DESCRIPTION OF THE PREFERRED EMBODIMENTS

FIG. 1 shows a charcoal grill 1 comprising a grill housing 2 and a cover 17. In the grill housing 2 a flap 18 is configured, the charcoal being able to be deposited through said flap into the grill housing 2 onto a charcoal rack 3, not visible in FIG. 1. The height of the charcoal rack 3 inside the grill housing 2 may be adjusted by means of a crank 15.

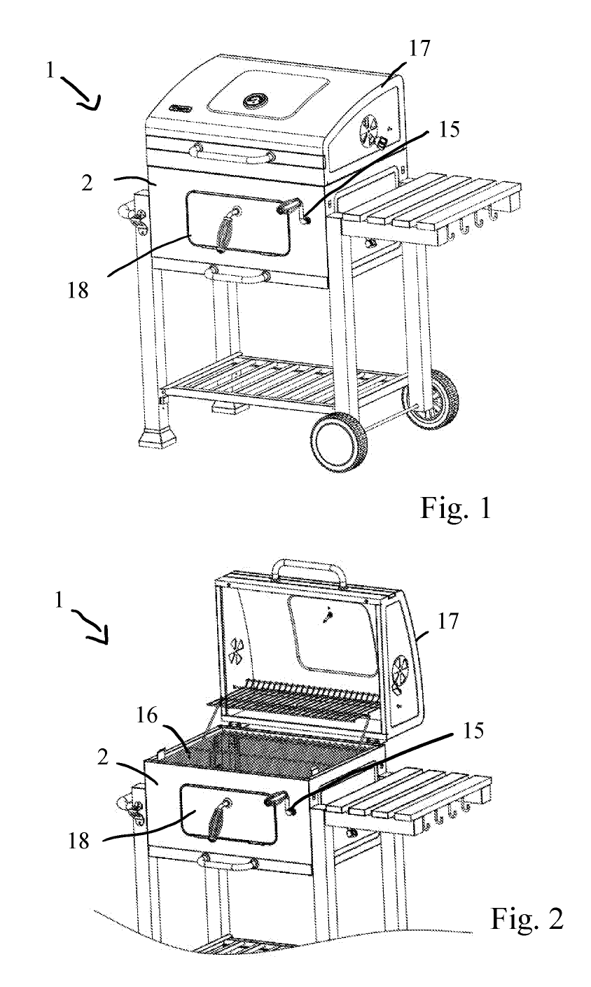

In FIG. 2 the charcoal grill 1 is shown with the cover 17 open, wherein a grill rack 16 which is able to be inserted into the grill housing 2 in a fixed manner is visible. In order to influence the heat which acts on the food to be grilled which has been deposited on the grill rack 16, the height of the charcoal rack 3 arranged below the grill rack 16, may be adjusted in the grill housing 2 by means of the crank 15.

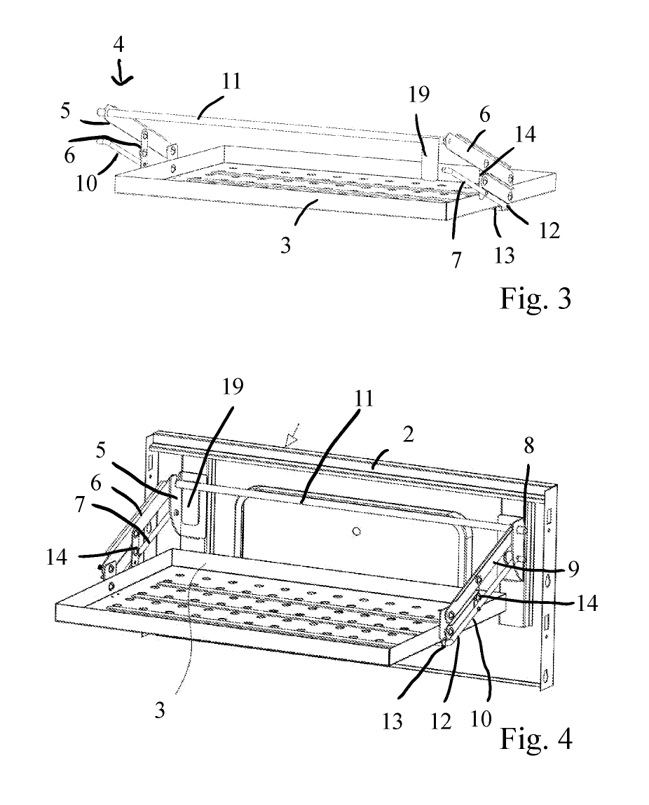

In FIG. 3 the charcoal rack 3 which is able to be removed together with a lifting device 4 from the grill housing 2 is shown. The lifting device 4 comprises a guide element 12 which forms on the side of the charcoal rack 3, shown here on the right, a first guide bar 7 and on the left-hand side a second guide bar 10. The guide bars 7, 10 of the guide elements 12 are connected together via a connecting portion 13 extending below the charcoal rack 3. The guide element 12 is rotatably mounted on the charcoal rack 3 so that the first guide bar 7 and the second guide bar 10 are pivotably mounted together on the charcoal rack 3.

The lifting device 4 further comprises a first actuating bar 6 on the right-hand side (according to FIG. 3) and a second actuating bar 9 on the left-hand side of the charcoal rack 3, which, in each case, are pivotably mounted on the charcoal rack 3. The first actuating bar 6 is connected to the first guide bar 7 by means of a connecting element 14 pivotably mounted on both, so that the first actuating bar 6 and the first guide bar 7 are always oriented parallel to one another. The second actuating bar 9 is also connected by means of a connecting element 14 to the second guide bar 10. Moreover, the ends of the first actuating bar 6 and the second actuating bar 9 are connected fixedly in terms of rotation to an actuating shaft 11. The actuating shaft 11 protrudes over the second actuating bar 9 and has an actuating element 19 in the region between the actuating bars 6, 9. The actuating element 19 is connected fixedly in terms of rotation to the actuating shaft 11.

In FIG. 4 the lifting device 4 and the charcoal rack 3 according to FIG. 3 are shown in a state mounted on the grill housing 2. A first bracket 5 and a second bracket 8 are attached to the grill housing 2. The actuating shaft 11 is suspended on a side of the charcoal rack 3 assigned to the first actuating bar 6 in the first bracket 5 and inserted into the second bracket 8 by the end protruding over the second actuating bar 9. The first guide bar 7 is inserted into the first bracket 5 while the second guide bar 10 is inserted with its angled end into the second bracket 8. The actuating bars 6, 9 are thus pivotably mounted on the brackets 5, 8 by means of the actuating shaft 11, while the guide bars 7, 10 are pivotably mounted directly on the brackets 5, 8. If the actuating element 19 is now pivoted away from the grill housing 2 by rotating the crank 5 into a thread attached to the grill housing 2, the actuating shaft 11 is rotated about its bearing in the brackets 5 and 8. As the actuating bars 6, 9 are rigidly connected to the actuating shaft 11, the actuating bars 6, 9 are pivoted upwardly by their ends connected to the charcoal rack 3, which results in the lifting of the charcoal rack 3. The guide bars 7, 10 ensure during this pivoting that the charcoal rack 3 always remains oriented horizontally even with an irregularly distributed load.

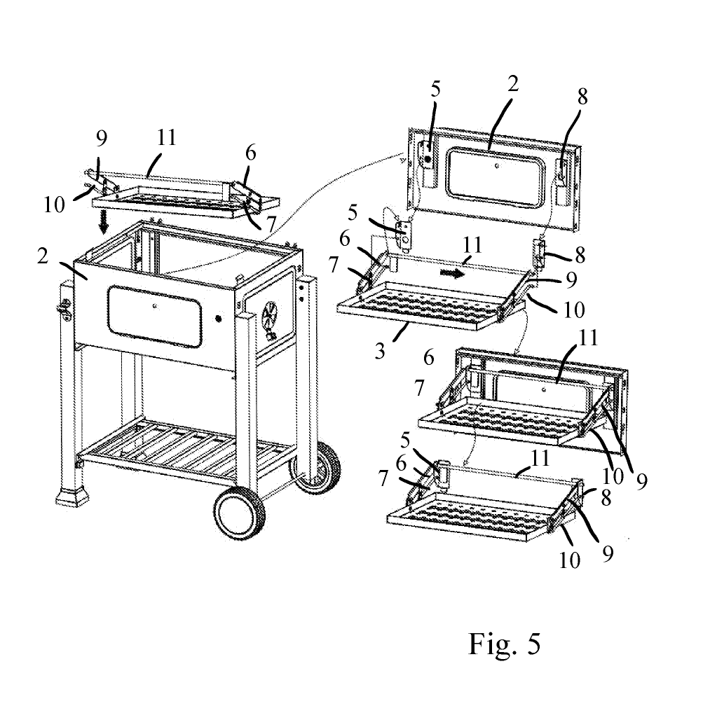

In FIG. 5, the individual mounting steps of the lifting device 4 and the charcoal rack 3 are indicated. The charcoal rack 3 is inserted with the lifting device 4 initially from above into the grill housing 2, wherein the actuating shaft 11 is initially inserted into the first bracket 5 on one side. Subsequently, the lifting device 4 together with the charcoal rack 3 is moved laterally, whereby the angled ends of the (first and second) guide bars 7, 10 are inserted into corresponding recesses in the brackets 5, 8. Additionally, with this lateral movement, the end of the actuating shaft 11 protruding over the second actuating bar 9 is inserted into a corresponding recess in the second bracket 8. For removing the charcoal rack 3 and the lifting device 4, the charcoal rack 3 and lifting device 4 have to be initially displaced to the side and then lifted out of the grill housing 2. The charcoal rack 3 is thus able to be installed and removed in a simple manner for cleaning.

The specification incorporates by reference the disclosure of DE 10 2015 109 093.7, filed Jun. 9, 2015.

The present invention is, of course, in no way restricted to the specific disclosure of the specification and drawings, but also encompasses any modifications within the scope of the appended claims.

### LIST OF REFERENCE NUMERALS

1 Charcoal grill
2 Grill housing
3 Charcoal rack
4 Lifting device
5 First bracket
6 First actuating bar
7 First guide bar
8 Second bracket
9 Second actuating bar
10 Second guide bar
11 Actuating shaft
12 Guide element
13 Connecting portion
14 Connecting element
15 Crank
16 Grill rack
17 Cover
18 Flap
19 Actuating element

1. A charcoal grill (1), comprising:
a grill housing (2);
a charcoal rack (3) arranged in the grill housing (2); and
a lifting device (4) for the charcoal rack (3);
a first actuating bar (6) pivotably mounted on the charcoal rack (3) on a first side of the charcoal rack (3) and pivotably mounted relative to a first bracket (5) configured in the grill housing (4);
a first guide bar (7) oriented parallel to the first actuating bar (6) and pivotably mounted on the charcoal rack (3) and pivotably mounted on the first bracket (5);
a second actuating bar (9) pivotably mounted on a second side of the charcoal rack (3) and pivotably mounted relative to a second bracket (8) configured in the grill housing (2);
a second guide bar (10) oriented parallel to the second actuating bar (9) and pivotably mounted on the charcoal rack (3) and pivotably mounted on the second bracket (8),
wherein the first actuating bar (6) and the second actuating bar (9) are connected together fixedly in terms of rotation at ends of the first actuating bar (6) and second actuating bar (9) that face the brackets (5, 8) by an actuating shaft (11), so that the charcoal rack (3) is lifted or lowered by rotating the actuating shaft (11), wherein the guide bars (7, 10) and the brackets (5, 8) are configured such that for attaching the charcoal rack (3), the actuating shaft (11) is initially introduced into the first bracket (5) and subsequently by axial displacement is inserted with one end into the second bracket (8), wherein at the same time the first guide bar (7) is inserted into the first bracket (5) and the second guide bar (10) is inserted into the second bracket (8).

2. The charcoal grill (1) according to claim 1, wherein the first guide bar (7) and the second guide bar (10) are inserted into the brackets (5, 8) in each case with an angled end.

3. The charcoal grill (1) according to claim 1, wherein the first guide bar (7) and the second guide bar (10) are formed as portions of a guide element (12) configured in one piece and a rotatably mounted connecting portion (13) of the guide element (12) extends below the charcoal rack (3).

4. The charcoal grill (1) according to claim 1, wherein the guide bars (7, 10) are formed from a rod-shaped material which is circular in cross section.

5. The charcoal grill (1) according to claim 1, wherein the actuating shaft (11) protrudes outwardly over the second actuating bar (9).

6. The charcoal grill (1) according to claim 1, wherein at least the first actuating bar (6) and the first guide bar (7) or the second actuating bar (9) and the second guide bar (10) are connected together via a connecting element (14) pivotably mounted on the bars.
